(19) United States
(12) Patent Application Publication
(10) Pub. No.: US 2026/0206892 A1
(43) Pub. Date: Jul. 23, 2026

(54) GARMENT

(71) Applicants: TORAY INDUSTRIES, INC., Chuo-ku, Tokyo (JP); TORAY INDUSTRIES (H.K.) LTD., Hong Kong (CN)

(72) Inventors: Takamitsu TANIGUCHI, Chuo-ku, Tokyo (JP); Tatsuya KIDO, Chuo-ku, Tokyo (JP); Shingo MATSUMOTO, Hong Kong (CN); Azuki OTSUKA, Hong Kong (CN)

(73) Assignees: TORAY INDUSTRIES, INC., Chuo-ku, Tokyo (JP); TORAY INDUSTRIES (H.K.) LTD., Hong Kong (CN)

(21) Appl. No.: 19/142,475

(22) PCT Filed: Jan. 5, 2024
(86) PCT No.: PCT/JP2024/000059

§ 371 Date: Jun. 23, 2025

(30) Foreign Application Priority Data
Jan. 11, 2023 (JP) 2023-002482

(51) Int. Cl. A41D 27/24; A41B 1/08

(52) U.S. Cl. CPC A41D 27/245; A41B 1/08; A41D 2300/52

(57) ABSTRACT

A garment includes an opening. The opening has a structure in which a fabric edge is folded, and at least a part of the fabric edge in the opening is sticked with an adhesive. A part of the opening has a shape having a changing radius of curvature, a folded hem width of the fabric edge in the opening at a portion having a smallest radius of curvature is the narrowest, and the folded hem width is changed to increase toward a portion having a large radius of curvature.

### CROSS REFERENCE TO RELATED APPLICATIONS

This application is the U.S. National Phase of PCT/JP2024/000059, filed Jan. 5, 2024, which claims priority to Japanese Patent Application No. 2023-002482, filed Jan. 11, 2023, the disclosures of these applications being incorporated herein by reference in their entireties for all purposes.

### FIELD OF THE INVENTION

The present invention relates to a garment.

### BACKGROUND OF THE INVENTION

As a technique of finishing an edge of a fabric forming an opening of a garment, there is a known technique of using an adhesive to stick the edge of the fabric that has been folded into two layers. For example, Patent Literature 1 proposes a garment excellent in stretchability and appearance with no need to perform finishing of the fabric edge, achieved by sticking the folded-back portion of the fabric edge with an adhesive applied in a dot shape.

### CITATION LIST

### Patent Literature

Patent Literature 1: JP 2021-25157 A

However, when the edge of the fabric forming the opening of the garment is folded into two layers and sticked with an adhesive, there is a problem. That is, in a concave portion having a curved shape and having a particularly small radius of curvature, for example, at the folded portion of the fabric edge near the concave portion of the V-neck, the fabric edge is expanded due to a difference between inner and outer circumferences, with wrinkles occurring by uneven tension on the fabric, leading to an impaired appearance of the garment. On the other hand, it is conceivable to narrow the width of the fold in order to reduce the occurrence of wrinkles due to uneven tension, but there is other problems in this method. That is, it is difficult to uniformly and stably fold the fabric along the curve with a changing radius of curvature, leading to a difficulty to form an opening with good appearance, and in addition, narrowing the width of the folding would lose firmness of the opening, leading to creating of the opening having a texture lacking strength.

The present invention has been made in view of the above, and an object of the present invention is to provide a garment having a characteristic such that, when a fabric edge curved in a concave shape and having a changing radius of curvature in an opening of the garment is folded into two layers and sticked using an adhesive, the garment can be stably provided with a folded opening with good appearance in accordance with a curve with the changing radius of curvature while reducing wrinkles caused by uneven tension occurring due to a difference between the inner and outer circumferences even in the fabric edge curved with a small radius of curvature, and the garment has an opening with firmness.

### SUMMARY OF THE INVENTION

In order to solve the above-described problems and achieve the object, the garment according to the present invention has the following configuration.
(1) A garment including an opening, in which the opening has a structure in which a fabric edge is folded, and at least a part of the fabric edge in the opening is sticked with an adhesive, and a part of the opening has a shape having a changing radius of curvature, a folded hem width of the fabric edge in the opening at a portion having a smallest radius of curvature is the narrowest, and the folded hem width is changed to increase toward a portion having a large radius of curvature.
(2) The garment according to (1), in which a width of a joint to which the adhesive is applied is changed in accordance with the change in the folded hem width.
(3) The garment according to (1) or (2), in which at least a part of the adhesive is applied in a line shape.
(4) The garment according to any one of (1) to (3), in which at least a part of the adhesive is applied in a dot shape.
(5) The garment according to any one of (1) to (4), in which the folded hem width of the fabric edge in the opening at the portion having the smallest radius of curvature is in a range of 2 mm to 6 mm, and the folded hem width of the fabric edge in the opening at a portion having a largest radius of curvature is in a range of 5 mm to 25 mm.
(6) The garment according to any one of (1) to (5), in which a ratio (A/B) of a folded hem width (A) of the fabric edge in the opening at the portion having the smallest radius of curvature to a folded hem width (B) of the fabric edge in the opening at a portion having a largest radius of curvature is in a range of 0.1 to 0.9.

According to the present invention, it is possible to provide a garment having a characteristic such that, when a fabric edge curved in a concave shape and having a changing radius of curvature in an opening of the garment is folded into two layers and sticked using an adhesive, the garment can be provided with an opening that can be folded stably in accordance with a curve with a changing radius of curvature while reducing wrinkles caused by uneven tension occurring due to a difference between the inner and outer circumferences even in the fabric edge curved with a small radius of curvature, and the garment can have an opening with firmness.

### BRIEF DESCRIPTION OF THE DRAWINGS

FIG. 1 is a view illustrating an appearance of a garment according to a first embodiment.

FIG. 2 is a view schematically illustrating an aspect of application of an adhesive applied to an opening of a collar of the garment according to the first embodiment.

FIG. 3 is a view schematically illustrating an aspect in which a fabric edge of the opening illustrated in FIG. 2 is folded and sticked.

FIG. 4 is a view illustrating an appearance of a garment according to a second embodiment.

FIG. 5 is a view schematically illustrating an aspect of application of an adhesive applied to an opening of a collar of the garment according to the second embodiment.

FIG. 6 is a view schematically illustrating an aspect in which a fabric edge of the opening illustrated in FIG. 5 is folded and sticked.

FIG. 7 is a view schematically illustrating another aspect in which a fabric edge of the opening of the garment according to the second embodiment is folded and sticked.

FIG. 8 is a view illustrating an appearance of a garment according to a third embodiment.

### DETAILED DESCRIPTION OF EMBODIMENTS OF THE INVENTION

Hereinafter, modes for carrying out the present invention (hereinafter, referred to as “embodiment”) will be described with reference to the accompanying drawings. Note that the drawings are merely schematic.

### First Embodiment

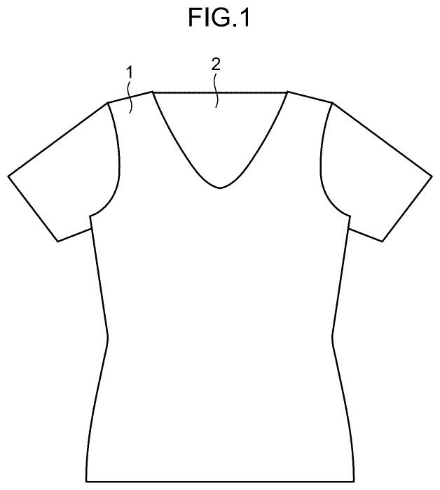

FIG. 1 is a view schematically illustrating an appearance of a garment according to a first embodiment. An opening 2 at the neckline of a garment 1 is formed by a curve, being curved in a concave shape and having a changing radius of curvature, and is specifically formed by a design curve typically referred to as a V-neck.

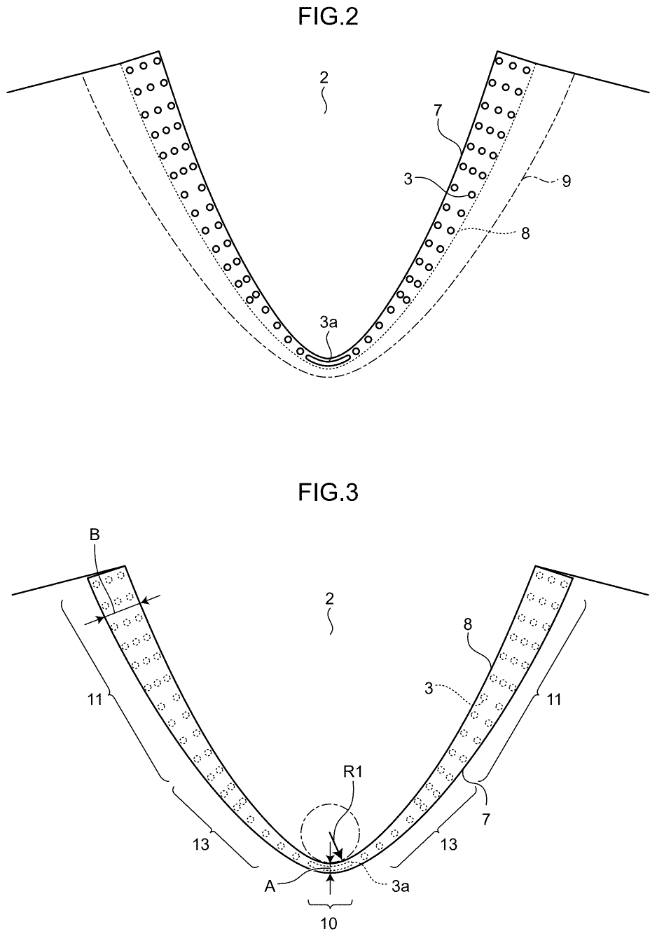

The radius of curvature in the present invention refers to a radius of a circle when a curve forming the opening 2 is locally regarded as an arc of the circle. The garment of the present invention includes: a portion where the arc locally forms the most gentle curve in the opening 2, that is, a portion having the largest radius of curvature; a portion where the arc locally forms the steepest curve in the opening 2, that is, a portion having the smallest radius of curvature; and a portion having a medium radius of curvature. FIG. 2 is a view illustrating a state in which an adhesive 3 is applied to a fabric edge 7 of the opening 2 at the neckline of the garment 1 illustrated in FIG. 1. FIG. 3 is a view illustrating a state in which the fabric edge 7 of FIG. 2 is folded and sticked. FIGS. 2 and 3 are views of the front body of the garment 1 as viewed from the inside (skin side).

As illustrated in FIG. 3, the first embodiment of the present invention is a garment 1 having an opening 2. It is important that the opening 2 has a structure in which the fabric edge 7 is folded, at least a part of the fabric edge 7 in the opening 2 is sticked with an adhesive 3, a part of the opening 2 has a shape having a changing radius of curvature, a folded hem width A of the fabric edge in the opening 2 at a portion 10 having a smallest radius of curvature is the narrowest, while a folded hem width at a portion having a larger radius of curvature, than at the portion 10 having the smallest radius of curvature, is changed to a greater width.

With this configuration, when the fabric edge 7 curved in a concave shape and having a changing radius of curvature is folded into two layers and sticked using the adhesive 3, it is possible, even in the fabric edge curved with a small radius of curvature, to obtain the opening 2 with firmness while being capable of reducing wrinkles caused by uneven tension occurring due to a difference between the inner and outer circumferences.

The opening 2 of the V-neck illustrated in FIG. 3 is formed by a combination of the portion 10 having the smallest radius of curvature, with left and right portions, namely, a portion 13 having a medium radius of curvature and a portion 11 having a largest radius of curvature, which are connected on both left and right sides of the portion 10 as a center. Regarding the portion 10 having the smallest radius of curvature, the smaller the radius of curvature, the sharper the V shape will be, which is preferred. Since the fabric edge 7 is folded to form the opening 2, the folded hem width A is formed to be narrow so as to suppress occurrence of wrinkles caused by uneven tension occurring due to the difference between the inner and outer circumferences. The smaller the folded hem width A, the better. However, the folded hem width A is to be preferably 2 mm to 6 mm in practice in order to be sticked with the adhesive 3, and the folded hem width A at the position corresponding to the vertex of the V shape is formed to be the narrowest.

In addition, in the opening 2 of the V-neck illustrated in FIG. 3, the folded hem width of the fabric edge 7 is changed corresponding to the radius of curvature so that the folded hem width A of the fabric edge 7 at the portion 10 having the smallest radius of curvature becomes the narrowest. That is, the folded hem width gradually increases from the portion 10 having the smallest radius of curvature toward the portion 13 having the medium radius of curvature and the portion 11 having the largest radius of curvature in this order. With this design, the portion 11 having the largest radius of curvature has a largest area in which the fabric is folded to form two layers, making it possible to obtain the opening 2 with firmness. A preferable folded hem width B at the portion 11 having the largest radius of curvature is not limited in a case where the portion has a large radius of curvature and is formed in substantially a straight line shape, although it depends on the radius of curvature. Even in a case where the portion has a curved shape, it is preferable to widen the folded hem width B within a range capable of suppressing the occurrence of wrinkles caused by uneven tension occurring due to a difference between the inner and outer circumferences. In practice, the folded hem width of about 5 mm to 25 mm is preferable.

A ratio (A/B) of the folded hem width A of the fabric edge in the opening 2 at the portion 10 having the smallest radius of curvature to the folded hem width B of the fabric edge in the opening 2 at the portion 11 having the largest radius of curvature is preferably in the range of 0.1 to 0.9. This is because it is possible, with this ratio, to suppress occurrence of wrinkles caused by uneven tension occurring due to the difference between the inner and outer circumferences of the curve in the portion 10 having the smallest radius of curvature when the fabric edge is folded to form the opening 2, and possible to obtain the opening 2 with firmness in the portion 11 having the largest radius of curvature. More preferably, the ratio is to be in the range of 0.2 to 0.6.

In the first embodiment of the present invention, as illustrated in FIG. 3, the width of the joint, which is a region where the adhesive 3 is applied, preferably is changed in accordance with the change in the folded hem width of the fabric. FIG. 3 illustrates an aspect in which the adhesive 3 is an adhesive applied in a dot shape. The row of the adhesive 3 is applied in a single row in the vicinity of the portion 10 having the smallest radius of curvature, and is applied with the number of rows being changed to a plurality of rows such as two rows and three rows toward the portion 11 having the largest radius of curvature. That is, there is also a change in the width of the joint which is the region to which the adhesive is applied. In addition, the portion where the adhesives 3 are applied in a plurality of rows is configured such that the plurality of rows include a row on the fabric edge side arranged substantially parallel to the fabric edge 7. With this arrangement, it is possible to prevent formation of an appearance in which the fabric is coming off with the fabric edge 7 functioning as a free end when the fabric edge 7 is folded into two layers at the folding line 8. Furthermore, the portion where the adhesive 3 is applied in a plurality of rows is configured such that the plurality of rows include a row on the folding line side arranged substantially parallel to the folding line 8. With this arrangement, when the fabric edge 7 curved in a concave shape and having a changing radius of curvature is folded into two layers and sticked using an adhesive, it is possible for an operator to easily recognize the change in the width of folding with a row in which the adhesive 3 is applied substantially parallel to the folding line 8 as a guideline. Specifically, when the operator controls the change in the width of the folding, it is possible to control the change in the width of the folding by grasping the position and line of the adhesive 3 by touching the hardness of the adhesive 3 by their fingers. This makes it possible for the operator to continuously allow the change in the width of the folding to emerge without hesitation, facilitating stable acquisition of folded parts with good appearance. Furthermore, with the width of the joint increasing toward the portion 11 having the largest radius of curvature, it is possible to obtain the opening 2 with firmness.

In the opening 2 in V-neck illustrated in FIG. 2, the row of the adhesives 3 on the fabric edge side arranged substantially parallel to the fabric edge 7 has a problem. That is, increasing the distance from the fabric edge 7 would lead to formation of an appearance in which the fabric is coming off with the fabric edge 7 functioning as a free end when the fabric edge 7 is folded into two layers by the folding line 8. Therefore, it is preferable that the row of adhesives 3 on the fabric edge side arranged substantially parallel to the fabric edge 7 be applied as close as possible to the fabric edge 7. The width at which the fabric edge 7 is a free end is preferably 2 mm or less, and more preferably 1 mm or less.

In addition, when the row of the adhesive 3 on the folding line side arranged substantially parallel to the folding line 8 is located at an excessively short distance to the folding line 8 in the opening 2 in the V-neck illustrated in FIG. 3, there occurs a problem of having dot shaped adhesives emerging on the surface of the fabric when the opening 2 is stretched, leading to an uneven appearance of the fabric edge 7. Therefore, the distance between the folding line 8 and the row of the adhesive 3 is preferably 0.5 mm or more, and more preferably 1.0 mm or more.

In the first embodiment of the present invention, as illustrated in FIG. 3, an adhesive 3a having a continuous line shape is applied at the portion 10 having the smallest radius of curvature in the opening 2. With this configuration, even with the narrowed folded hem width at the portion 10 having the smallest radius of curvature, high peel strength is easily obtained.

In a case where the adhesive 3a in a line shape is not applied and the adhesive 3 in a dot shape, which is applied in the portion 13 having a medium radius of curvature and in the portion 11 having the largest radius of curvature, is applied in the portion 10 having the smallest radius of curvature in the opening 2, there is an effect of suppressing hindrance of an elongation property of the fabric. In this case, the fabric edge would be easily expanded when the portion 10 having the smallest radius of curvature is folded, leading to suppression of occurrence of wrinkles caused by uneven tension, and facilitation of obtaining the elongation property in the entire opening 2 of the collar. These options can be freely selected in consideration of which form is more preferable for balancing the elongation property and peel strength of the fabric.

In the opening 2 in the V-neck illustrated in FIG. 3, the adhesive 3a having a continuous line shape is arranged in the portion 10 having the smallest radius of curvature at a position including the vertex of the V-neck. By arranging the adhesive 3a having the continuous line shape, the bonding area of the adhesive 3a having the continuous line shape becomes larger than a bonding area of the adhesive 3 having a dot shape to sufficiently obtain the peel strength. Therefore, this arrangement is preferable in the vicinity of the vertex of the V-neck where the peel strength tends to be insufficient even with the narrowed folded hem width A. The adhesive 3a having the continuous line shape, preferably has a length twice or more the width thereof. In practice, it is preferable to apply the adhesive 3a adjacent in a dot shape to be close to each other so as to come in contact with each other to be applied as an adhesive continuous in a line shape.

In the first embodiment of the present invention, as illustrated in FIG. 3, a smallest radius of curvature R1 of the opening 2 is preferably 5 cm or less. This makes it possible to facilitate acquisition of the effect of reducing wrinkles caused by uneven tension due to the difference between the inner and outer circumferences when the fabric edge 7 is folded. The radius of curvature R1 is a radius of a circle being in contact with a portion 10 having the smallest radius of curvature by a length substantially the same as the radius of curvature. When the radius of curvature R1 is as small as 1 cm or less, it is difficult to fold the fabric with a smooth curve even when the folded hem width A is set to be narrow, and the fabric tends to have an angled curve connecting short straight lines. However, when the fabric edge 7 is folded and sticked with the adhesive 3 or the adhesive 3a, the fabric edge 7 will be the same as in the case of the garment of the present invention.

As for the shape of the adhesive 3, it is preferable to apply the adhesive 3 in a planar shape in accordance with the change in the width of the folding to obtain sufficient firmness, but the adhesive 3 may be applied in a line shape as well. With the adhesive being applied in a line shape, not only the firmness are easily obtained, but also moderate softness is easily obtained. Examples of conceivable and preferable application of the adhesive in a planar shape include: cutting a film adhesive in accordance with a change in the width of the joint for application and bonding; and applying a gel adhesive in accordance with a change in the width of the joint and then spreading the applied adhesive by pressurization for bonding so that adjacent adhesives are brought into contact with each other and integrated into a joint similar to the film adhesive. Examples of conceivable and preferable examples of the adhesive in a line shape include application of the adhesive so as to be arranged substantially in parallel in accordance with a change in the width of the joint, or so as to be arranged in a lattice shape. In addition, the adhesive 3 is preferably applied in a dot shape. This makes it easy to obtain the opening with firmness without impairing the elongation property of the fabric.

A preferable size of the adhesive 3 in a dot shape varies depending on the structure and thickness of the fabric constituting the garment 1. When the dot has a diameter of about 1.0 mm to 2.0 mm, a relatively strong firmness is easily obtained. However, when the fabric is thin, the adhesive would noticeably seep out to the front side of the fabric to impair the appearance. Therefore, it is preferable to set the dot size to small within a range in which the necessary firmness can be obtained. An adhesive dot having a diameter of 1.0 mm or less is preferable because it would not cause seepage even in the case of an innerwear fabric having a fabric thickness of about 0.5 mm to 0.8 mm. Furthermore, an adhesive dot having a diameter of 0.6 mm or less is more preferable to prevent the seepage from becoming noticeable even in a thinner fabric having a fabric thickness of about 0.3 mm to 0.5 mm. A decrease in the firmness of the fabric because of a smaller diameter of the adhesive 3 can be compensated by reducing the interval between the adhesives 3.

The adhesive 3 in a dot shape has a round shape in the first embodiment, but is not limited thereto. The shape may be any shape as long as the adhesive 3 can be repeatedly applied in a separated state, and may be a line shape as long as it is not continuous, may be a geometric shape such as a triangle, a square, or an ellipse, or may be a shape obtained by combining these shapes.

The garment 1 of the first embodiment of the present invention is formed with a stretchable fabric. For example, as long as the material is a knitted material provided as a general clothing material, the circular knitting or warp knitting material has stretchability required for carrying out the present invention, with no limitation. Even in the case of a woven fabric material, a material having stretchability usable for clothing is suitable for the present invention. In addition to a typical underwear and a padded camisole, the application can be applied to a material of an outer wear such as a T-shirt or other cut-and-sew garment, with no limitation.

The resin constituting the adhesive 3 is preferably a synthetic resin rather than a natural resin, and a thermoplastic resin is more preferable, among synthetic resins. For example, as long as the resin is formed of a polymer compound, various resins can be used with no limitation; examples of this includes polyethylene, polypropylene, polyvinyl chloride, polystyrene, polyvinyl acetate, polyurethane, polytetrafluoroethylene, polyacryl, polyamide, polyacetal, polycarbonate, polyphenylene ether, polyester, polyphenylene sulfide, polysulfone, polyether sulfone, polyether ether ketone, polyimide, or polyamide-imide.

The resin constituting the adhesive 3 is preferably a reactive hot-melt adhesive. When the resin is reactive hot-melt, the resin softens or melts to penetrate between the structures of the bonding site, and reacts with surrounding moisture after cooling and solidification, promoting crosslinking to form an adhesive structure excellent in heat resistance, solvent resistance, and the like.

### Second Embodiment

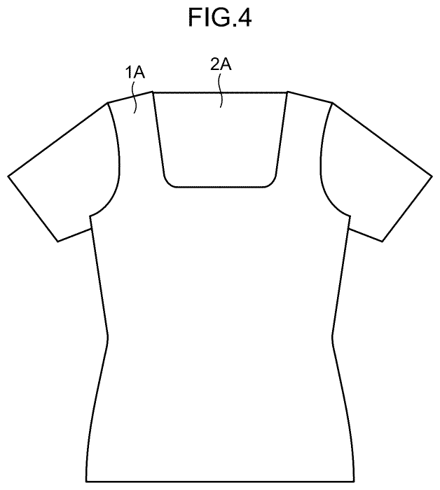

FIG. 4 is a view schematically illustrating an appearance of a garment 1A according to a second embodiment. The garment 1A includes, at its neckline, an opening 2A formed with a curve in a concave shape with a changing radius of curvature, typically formed with a designed curve referred to as a square neck.

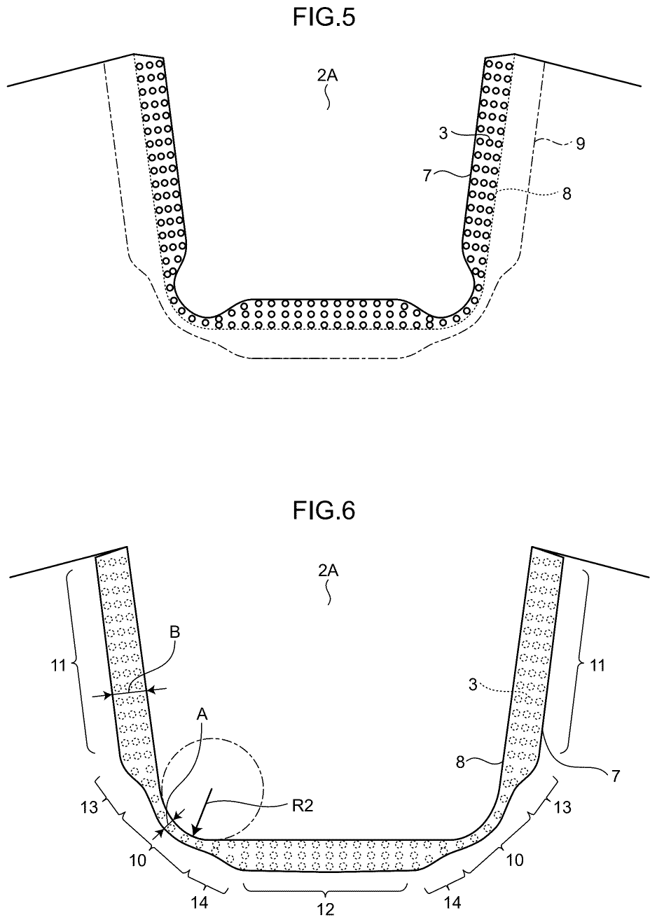

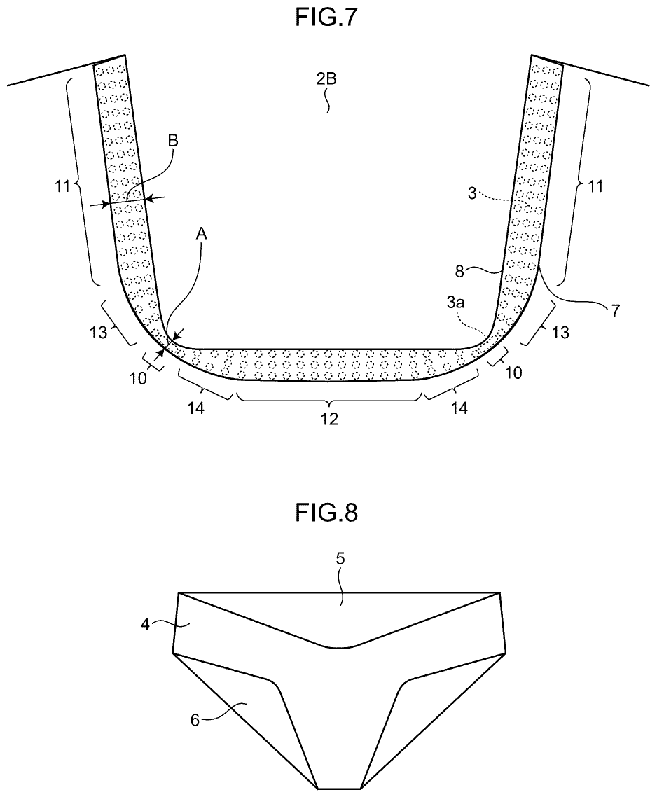

FIG. 5 is a view illustrating a state in which the adhesive 3 is applied to the opening 2A at the neckline of the garment 1A illustrated in FIG. 4. FIG. 6 is a view illustrating a state in which the fabric edge 7 of the opening 2A is folded and sticked. FIG. 7 is a view illustrating another aspect of an opening 2B in which the fabric edge 7 is folded and sticked. FIGS. 5 to 7 are views of the inside (skin side) of the garment 1.

The opening 2A as the square neck illustrated in FIG. 6 is formed by a combination of a portion 10 having the smallest radius of curvature, with left and right portions, namely, portions 13 and 14 having a medium radius of curvature, and portions 11 and 12 having a largest radius of curvature, which are connected on both left and right sides of the portion 10 as a center. Regarding the portion 10 having the smallest radius of curvature, the smaller the radius of curvature, the sharper the square shape will be, which is preferred. Since the fabric edge is folded to form the opening, the folded hem width is formed to be narrow so as to suppress occurrence of wrinkles caused by uneven tension occurring due to the difference between the inner and outer circumferences. The smaller the folded hem width A, the better. However, the folded hem width A is to be preferably 2 mm to 6 mm in practice in order to be sticked with the adhesive, and it is preferable, regarding its position, to form such that the width A at least at the position corresponding to the vertex of the corner is the narrowest.

In addition, in the opening 2A of the square neck illustrated in FIG. 6, the folded hem width of the opening 2A is changed so that the folded hem width A of the fabric edge 7 at the portion 10 having the smallest radius of curvature becomes the narrowest. That is, the folded hem width gradually increases from the portion 10 having the smallest radius of curvature toward the portion 11 having the largest radius of curvature. In addition, the folded hem width gradually increases from the portion 10 having the smallest radius of curvature toward the portion 12 having the largest radius of curvature. Between the portion 10 having the smallest radius of curvature and each of the portions 11 and 12 having the largest radius of curvature, there are portions 13 and 14 each having a medium radius of curvature. The folded hem width at each of the portions 13 and 14 having the medium radius of curvature is a medium width falling between the portion 10 having the smallest radius of curvature and the portions 11 and 12 having the largest radius of curvature. With this design, the portion 11 or 12 having the largest radius of curvature has a largest area in which the fabric is folded to form two layers, making it possible to obtain the opening 2A with firmness. The preferable folded hem width at each of the portion 11 or 12 having the largest radius of curvature is not limited in a case where the radius of curvature is large and the shape is substantially a straight line shape, although it depends on the radius of curvature. Even in a case where the portion has a curved shape, it is preferable to widen the folded hem width within a range capable of suppressing occurrence of wrinkles caused by uneven tension occurring due to a difference between the inner and outer circumferences. In practice, the folded hem width of about 5 mm to 25 mm is preferable.

The ratio (A/B) of the folded hem width A of the fabric edge in the opening 2A at the portion 10 having the smallest radius of curvature to the folded hem width B of the fabric edge in the opening 2A at the portions 11 and 12 having the largest radius of curvature is preferably in the range of 0.1 to 0.9. This is because it is possible, with this ratio, to suppress occurrence of wrinkles caused by uneven tension occurring due to the difference between the inner and outer circumferences of the curve in the portion having the smallest radius of curvature when the fabric edge is folded to form the opening, and possible to obtain the opening 2A with firmness in the portions 11 and 12 having the largest radius of curvature. More preferably, the ratio is to be in the range of 0.2 to 0.6.

In the second embodiment of the present invention, as illustrated in FIG. 6, regarding the width of the joint to which the adhesive 3 is applied, the width of the joint which is a region to which the adhesive 3 is applied is also preferably changed in accordance with the change in the folded hem width of the fabric edge 7. FIG. 6 illustrates an aspect in which the adhesive 3 is an adhesive applied in a dot shape. The row of the adhesives 3 is applied in a single row in the vicinity of the portion 10 having the smallest radius of curvature, and the adhesives 3 are applied in a plurality of rows such as two rows and three rows from the portions 13 and 14 having the medium radius of curvature toward the portions 11 and 12 having the largest radius of curvature. That is, there is a change in the width of the joint to which the adhesive 3 is applied. In addition, the portion where the adhesives 3 are applied in a plurality of rows is configured such that the plurality of rows include a row on the fabric edge side arranged substantially parallel to the fabric edge 7. With this arrangement, it is possible to prevent formation of an appearance in which the fabric is coming off with the fabric edge 7 functioning as a free end when the fabric edge 7 is folded into two layers at the folding line 8.

Furthermore, the portion where the adhesive 3 is applied in a plurality of rows is configured such that the plurality of rows to include a row on the folding line side arranged substantially parallel to the folding line 8. With this arrangement, when the fabric edge 7 curved in a concave shape and having a changing radius of curvature is folded into two layers and sticked using an adhesive, it is possible for an operator to easily recognize the change in the width of folding with a row in which the adhesive 3 is applied substantially parallel to the folding line 8 as a guideline. Specifically, when the operator controls the width of the folding, it is possible to control the width of the folding by grasping the position and line of the adhesive 3 by touching the hardness of the adhesive 3 by their fingers. This makes it possible for the operator to continuously allow the change in the width of the folding to emerge without hesitation, facilitating stable acquisition of folded parts with good appearance. Furthermore, with the width of the joint increasing toward the portions 11 and 12 having the largest radius of curvature, it is possible to obtain the opening 2A with firmness.

In FIG. 6, the folded hem widths at the portions 11 and 12 having the largest radius of curvature are constant with no change. This makes it possible to obtain a garment with good appearance in which a straight line shape is emphasized in a square shape constituted by a substantially straight line.

Furthermore, in the opening 2B of the square neck illustrated in FIG. 7, an adhesive 3a in a straight line shape is applied to the portion 10 having the smallest radius of curvature, so as to decrease the range of the portion 10 having the smallest radius of curvature, that is, further decreasing the radius of curvature at the portion 10 in FIG. 7 with respect to the radius of curvature at the portion 10 in FIG. 6. This forms the folded hem width to gently increase at the portions 13 and 14 of a medium radius of curvature. With this configuration, the line formed by the fabric edge 7 has a concave curve over the entire opening 2B, leading to acquisition of a garment with a further enhanced appearance.

The ratio (A/B) of the folded hem width A of the fabric edge in the opening 2B at the portion 10 having the smallest radius of curvature to the folded hem width B of the fabric edge in the opening 2B at the portions 11 and 12 having the largest radius of curvature is preferably in the range of 0.1 to 0.9. This is because it is possible, with this ratio, to suppress occurrence of wrinkles caused by uneven tension occurring due to the difference between the inner and outer circumferences of the curve in the portion having the smallest radius of curvature when the fabric edge is folded to form the opening, and possible to obtain the opening 2B with firmness in the portions 11 and 12 having the largest radius of curvature. More preferably, the ratio is to be in the range of 0.2 to 0.6.

### Third Embodiment

FIG. 8 is a view illustrating an appearance of a garment 4 according to a third embodiment. The garment 4 is an example of an underwear, and has openings 5 and 6 through which a torso and legs pass, respectively. Similarly to the garments of the first and second embodiments, the openings 5 and 6 are formed in a pattern with a changing radius of curvature. Also in the third embodiment, similarly to the first and second embodiments, the effect of the present invention can be obtained by using a configuration in which the folded hem width of the fabric edge at the portion having the smallest radius of curvature of the openings 5 and 6 is the narrowest, and the folded hem width is changed to increase toward the portion having the largest radius of curvature.

While the embodiments for carrying out the present invention have been described so far, the present invention should not be limited by the above-described embodiments. For example, a similar effect may be imparted to an opening of garment such as a hat or an arm cover.

### Implementation Examples

### Implementation Example 1

As implementation example 1, a typical underwear having a V-neck design as illustrated in FIGS. 1 and 3 was produced. The curve of the V-neck was formed such that the radius of curvature in the vicinity of the vertex of the V-neck was set to 0.5 cm, and the portion 11 having the largest radius of curvature connected to the vertex was formed to have a length of 30 cm so as to form a gentle curve similar to a gentle curve of a typical V-neck as illustrated in FIG. 3.

The folded hem width was set to 2 mm at the vertex of the V-neck, and the folded hem width was set to gradually widen from the vertex to the upper end of the portion 11 having the largest radius of curvature, so as to set the folded hem width at the upper end of the front body to 7 mm.

As illustrated in FIG. 3, a row of the adhesive 3 in a dot shape having a diameter of 1 mm was applied along a position 1 mm from the fabric edge 7, and the same row of the adhesive 3 in a dot shape was applied along a position 1 mm from the folding line 8. The adhesive in a dot shape was also applied to the vertex portion of the V-neck. In addition, the number of rows of the adhesive 3 in a dot shape was divided into three substantially equal parts of upper, middle, and lower parts for each of the left and right sides of the length of the folding line 8 of the opening 2, with the three parts including three rows of the upper part, two rows of the middle part, and one row of the lower part. Thereafter, the fabric edge was folded and sticked with the adhesive to obtain implementation example 1 of the present invention. The configuration and evaluation results of implementation example 1 are illustrated in Table 1.

### Implementation Example 2

Implementation example 2 produces a typical underwear having a square neck design as illustrated in FIGS. 4 and 6. The curve of the square neck was formed such that the radius of curvature at the corner of the square neck was 3 cm, and the portions 11 and 12 having the largest radius of curvature connected to the corner were formed to be substantially straight lines, that is, to have a length of 200 cm, similarly to the typical square neck as illustrated in FIG. 6.

The folded hem width was set to 2 mm at the corner portion of the square neck, and was set to be constant at 7 mm at the portions constituted by a substantially straight line. In addition, the portions 13 and 14 having the medium radius of curvature are formed to have a gradually increasing folded hem width.

As illustrated in FIG. 5, a row of the adhesive 3 in a dot shape having a diameter of 1 mm was applied along a position 1 mm from the fabric edge 7, and the same row of the adhesive 3 in a dot shape was applied along a position 1 mm from the folding line 8. In addition, the number of rows of the adhesive 3 in dot shape was set to have three rows in a portion constituted by a substantially straight line, one row in a corner portion having the smallest radius of curvature, and two rows in a portion having a changing folded hem width between the two portions. Thereafter, the fabric edge was folded and sticked with the adhesive to obtain implementation example 2 of the present invention. The configuration and evaluation results of implementation example 2 are illustrated in Table 1.

### Implementation Example 3

Regarding implementation example 3, the setting similar to implementation example 1 was used to obtain implementation example 3 of the present invention, except for the following two points.
(1) The point where the radius of curvature in the vicinity of the vertex of the V-neck was set to 5 cm and the folded hem width was set to 4 mm.
(2) The point, as illustrated in FIG. 3, where an adhesive in a line shape having a width of 1 mm and a length of 10 mm was applied to the vertex of the V-neck.

The configuration and evaluation results of implementation example 3 are illustrated in Table 1.

### Comparative Example 1

Regarding comparative example 1, the setting similar to implementation example 1 was used to obtain comparative example 1 of the present invention, except for the following two points.
(1) The point where the radius of curvature in the vicinity of the vertex of the V-neck was set to 6 cm, and the folded hem width at all portions in a range from a portion having a small radius of curvature to a portion having a large radius of curvature was set to 7 mm.
(2) The point where three rows of adhesive in a dot shape were applied to all portions in a range from a portion having a small radius of curvature to a portion having a large radius of curvature.

The configuration and evaluation results of comparative example 1 are illustrated in Table 1.

### Comparative Example 2

Regarding comparative example 2, the setting similar to implementation example 1 was used to obtain comparative example 2 of the present invention, except for the following two points.
(1) The point where the folded hem width at all portions in a range from a portion having a small radius of curvature to a portion having a large radius of curvature was set to 2 mm.
(2) The point where one row of adhesive in a dot shape was applied in all portions in a range from a portion having a small radius of curvature to a portion having a large radius of curvature.

The configuration and evaluation results of comparative example 2 are illustrated in Table 1.

TABLE 1

| | | Implementation | Implementation | Implementation | Comparative | Comparative |
|---|---|---|---|---|---|---|
| | | Example 1 | Example 2 | Example 3 | Example 1 | Example 2 |
| Design | | V-Neck | Square Neck | V-Neck | V-Neck | V-Neck |
| Smallest Radius of Curvature | cm | 0.5 | 3 | 5 | 6 | 0.5 |
| Folded Hem Width [A] at Portion | mm | 2 | 2 | 4 | 7 | 2 |
| Having Smallest Radius of Curvature | | | | | | |
| Folded Hem Width [B] at Portion | mm | 7 | 7 | 7 | 7 | 2 |
| Having Large Radius of Curvature (at | | | | | | |
| Maximum) | | | | | | |
| Ratio [A/B] of Folded Hem Width | | 0.3 | 0.3 | 0.6 | 1.0 | 1.0 |
| Number of Rows of Adhesive in Portion | Rows | 1 | 1 | 1 | 3 | 1 |
| Having Smallest Radius of Curvature | | | | | | |
| Number of Rows of Adhesive in Portion | Rows | 3 | 3 | 3 | 3 | 1 |
| Having Large Radius of Curvature (at | | | | | | |
| Maximum) | | | | | | |
| Arrangement of Row of Adhesive | | Present | Present | Present | Present | Present |
| Arranged in Parallel to Fabric Edge | | | | | | |
| Presence/Absence of Row of Adhesive | | Present | Present | Absent | Present | Present |
| Arranged in Parallel to Folding Line | | | | | | |
| Presence/Absence of Line Shaped | | Absent | Absent | Present | Absent | Absent |
| Adhesive Arranged in Portion Having | | | | | | |
| Smallest Radius of Curvature | | | | | | |
| Evaluation of Texture | | Good: With | Good: With | Good: With | Good: With | Poor: |
| | | Appropriate | Appropriate | Appropriate | Appropriate | Insufficient |
| | | Firmness | Firmness | Firmness | Firmness | Firmness |
| Evaluation of Appearance | | Good | Good | Satisfactory | Poor: | Poor: Folded |
| | | | | | Occurrence of | Portion Is Not |
| | | | | | Wrinkles | Stable |
| | | | | | Caused by | |
| | | | | | Uneven Tension | |

### REFERENCE SIGNS LIST

1, 1A, 1B, 4 GARMENT
2, 2A, 2B OPENING AT NECKLINE
3, 3a ADHESIVE
5 OPENING TO TORSO
6 OPENING TO LEGS
7 FABRIC EDGE
8 FOLDING LINE
9 SCHEDULED LINE AFTER FOLDING
10 PORTION HAVING SMALLEST RADIUS OF CURVATURE
11, 12 PORTION HAVING LARGEST RADIUS OF CURVATURE
13, 14 PORTION HAVING MEDIUM RADIUS OF CURVATURE
A, B FOLDED HEM WIDTH
R1, R2 RADIUS OF CURVATURE

1. A garment comprising an opening,
wherein the opening has a structure in which a fabric edge is folded, and at least a part of the fabric edge in the opening is sticked with an adhesive, and
a part of the opening has a shape having a changing radius of curvature, a folded hem width of the fabric edge in the opening at a portion having a smallest radius of curvature is the narrowest, and the folded hem width is changed to increase toward a portion having a large radius of curvature.

2. The garment according to claim 1, wherein a width of a joint to which the adhesive is applied is changed in accordance with the change in the folded hem width.

3. The garment according to claim 1, wherein at least a part of the adhesive is applied in a line shape.

4. The garment according to claim 1, wherein at least a part of the adhesive is applied in a dot shape.

5. The garment according to claim 1, wherein the folded hem width of the fabric edge in the opening at the portion having the smallest radius of curvature is in a range of 2 mm to 6 mm, and the folded hem width of the fabric edge in the opening at a portion having a largest radius of curvature is in a range of 5 mm to 25 mm.

6. The garment according to claim 1, wherein a ratio (A/B) of a folded hem width (A) of the fabric edge in the opening at the portion having the smallest radius of curvature to a folded hem width (B) of the fabric edge in the opening at a portion having a largest radius of curvature is in a range of 0.1 to 0.9.
